(19) United States
(12) Patent Application Publication
(10) Pub. No.: US 2007/0222393 A1
(43) Pub. Date: Sep. 27, 2007

(54) ELECTRON EMITTING DEVICE

(75) Inventors: Iwao Ohwada, Nagoya-city (JP); Takayoshi Akao, Nagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/536,873

(22) Filed: Sep. 29, 2006

(30) Foreign Application Priority Data
Mar. 24, 2006 (JP) 2006-083264

(51) Int. Cl. G09G 3/10

(52) U.S. Cl. 315/169.2; 315/169.1

(57) ABSTRACT

The electron emitting device 10 includes a substrate 11, a lower electrode 12, an emitter section 13, an upper electrode 14. The upper electrode disposed above the emitter section to oppose the lower electrode so as to sandwich the emitter section with the lower electrode. The upper electrode has a plurality of micro through holes. The upper electrode is configured in such a manner that distance t1 (gap distance t1) between the lower surface of the upper electrode in the vicinity of the micro through holes 14c and the upper surface of the emitter section is substantially constant for any of the micro through holes.

### BACKGROUND OF THE INVENTION

1. Field of the Invention

The present invention relates to an electron emitting device (or element) including an emitter section composed of a dielectric material, a lower electrode, and an upper electrode having micro through holes, the electron emitting device emitting electrons accumulated on the emitter section through the micro through holes.

2. Description of the Related Art

One of conventional electron emitting devices, as shown in FIG. 15, includes an emitter section 101, a lower electrode 102, and an upper electrode 103. The emitter section 101 is composed of a dielectric material. An upper surface of the emitter section 101 has irregularities (asperity) formed by crystal grain boundaries of the dielectric material. The lower electrode 102 is disposed (formed) on a lower surface of the emitter section 101. The upper electrode 103 is disposed (formed) on the upper surface of the emitter section 101 to oppose the lower electrode 102 to sandwich the emitter section 101 with the lower electrode 102. A great number of micro through holes 103a are formed in the upper electrode 103. A lower surface of the upper electrode 103 in the vicinity of the micro through holes 103a is apart (distant) from the upper surface of the emitter section 101 due to the irregularities (asperity) on an upper portion of the emitter section 101. A structure thus formed by the upper electrode 103 and the emitter section 101 is called “an eaves structure” (see Japanese Patent Application Laid-Open (kokai) No. 2005-142134).

An operation of the electron emitting device is described. Assuming that the an actual potential difference Vka (i.e., an element voltage Vka) between the lower electrode 102 and the upper electrode 103 with reference to a potential of the lower electrode 102 is maintained at a predetermined positive voltage Vp (i.e., a voltage Vp is applied between upper electrode and the lower electrode), and no electrons are accumulated on the upper surface of the emitter section 101, a negative pole of each of dipoles in the emitter section 103 is oriented toward the upper surface of the emitter section 101 (i.e., oriented in the positive direction of a Z axis toward the upper electrode 103). This state is observed at a point p1 on a graph in FIG. 16. The graph in FIG. 16 shows the polarization-element voltage characteristic (Q-V characteristic) of the electron emitting device.

In the stage above, when a negative predetermined voltage Vm is applied between the upper electrode and the lower electrode, the element voltage Vka decreases toward a point p3 via a point p2 in FIG. 16. When the element voltage Vka is decreased to a voltage near a negative coercive field voltage Va shown in FIG. 16, the dipoles in the emitter section 101 start reversing in such a manner that the negative pole of each of the dipoles in the emitter section 101 is oriented toward the lower electrode 102. In other words, as shown in FIG. 17, a polarization reversal (or a negative-side polarization reversal) begins. The polarization reversal increases (strengthen) an electric field in the contact sites (triple junctions) between the upper surface of the emitter section 101, the upper electrode 103, and an ambient medium (in this embodiment, vacuum) and/or an electric field near the triple junctions. As a result, electrons begin to be supplied toward the emitter section 101 from the upper electrodes 103.

The supplied electrons are accumulated mainly on the upper portion of the emitter section 101 near regions exposed through the micro through holes 103a and near the distal end portions of the upper electrode 103 that define the micro through holes 103a. Subsequently, when the negative-side polarization reversal is completed after certain time, the element voltage Vka rapidly changes toward the negative predetermined voltage Vm, eventually reaching the negative predetermined voltage Vm. As a result, the electron accumulation is completed, i.e., a saturation state of electron accumulation is reached. This state is observed at a point p4 in FIG. 16.

Thereafter, a positive predetermined voltage Vp is applied between the upper electrode and the lower electrode, the element voltage Vka starts to increase. During the increase, when the element voltage Vka exceeds a positive coercive field voltage Vd corresponding to a point p5 in FIG. 16, the negative pole of the dipole starts to orient toward the upper surface of the emitter section 13 (i.e., toward the upper electrode 103), as shown in FIG. 18. In other words, a positive-side polarization reversal begins. Subsequently, the number of dipoles which completed the positive-side polarization reversal increases, the electrons accumulated on the upper portion of the emitter section 101 start to be emitted through the micro through holes 103a in the upward direction by Coulomb repulsion from the dipoles. Thereafter, when all of the dipoles complete the positive-side polarization reversal, the element voltage Vka starts to increase rapidly and reaches the positive predetermined voltage Vp. As a result, the state of the emitter section 101 returns to its original state shown in FIG. 15 (point p1 shown in FIG. 16).

### SUMMARY OF THE INVENTION

As described above, the electrons accumulated on the upper surface of the emitter section 101 are emitted when the electrons receive the Coulomb repulsion larger than a certain force caused by the dipoles that completed the positive-side polarization reversal. In other words, the accumulated electrons are not emitted unless density of the dipoles that completed the positive-side polarization reversal in the upper portion of the emitter section 103 exceeds a certain required value. Meanwhile, the number of the dipoles that undergo the positive-side polarization reversal in the upper potion of the emitter section 101 increases as the potential of the upper surface of the emitter section 101 Vfer (hereinafter may be called “emitter section voltage Vfer”) with reference to the potential of the lower electrode 102 becomes larger. That is, the electrons are not emitted unless the emitter section voltage Vfer becomes equal to or exceeds a predetermined potential Vth.

Now, potential at a point Q1 and potential at a point Q2 on the upper surface of the emitter section 101 shown in FIG. 19 are discussed, on the assumption that a voltage Vin is applied between the upper electrode and the lower electrode. Distance (gap distance) between the point Q1 and the lower surface of the upper electrode 103 is relatively small distance d1. Distance (gap distance) between the point Q2 and the lower surface of the upper electrode 103 is distance d2 which is larger than the distance d1.

When focusing attention on the point Q1, as shown in FIG. 19, a capacitor Cf1 (a capacitor whose capacitance is Cf1) is formed in the emitter section 101 of the dielectric material between the lower electrode 102 and the point Q1 on the upper surface of the emitter section 101, and another capacitor Cg1 (another capacitor whose capacitance is Cg1) is formed in the space between the point Q1 and the lower surface of the upper electrode 103. That is, it can be presumed that the upper electrode and the lower electrode are connected by an equivalent line in which the capacitor Cf1 and the capacitor Cg1 are connected serially each other along a region passing through the point Q1. Likewise, when focusing attention on the point Q2, a capacitor Cf2 (a capacitor whose capacitance is Cf2) is formed in the emitter section 101 of the dielectric material between the lower electrode 102 and the point Q2 on the upper surface of the emitter section 101, and another capacitor Cg2 (another capacitor whose capacitance is Cg2) is formed in the space between the point Q2 and the lower surface of the upper electrode 103. That is, it can be presumed that the upper electrode and the lower electrode are connected by an equivalent line in which the capacitor Cf2 and the capacitor Cg2 are connected serially each other along a region passing through the point Q2.

The following expression (1) holds when inter-electrode voltage of the capacitor Cg1 and inter-electrode voltage of the capacitor Cf1 are represented by Vgap1 and Vfer1, respectively, and the following expression (2) holds when inter-electrode voltage of the capacitor Cg2 and inter-electrode voltage of the capacitor Cf2 are represented by Vgap2 and Vfer2, respectively.

Vin=Vgap1+Vfer1 (1)

Vin=Vgap2+Vfer2 (2)

As mentioned above, the distance d1 is smaller than the distance d2 (d1<d2). Therefore, the capacitance Cg1 is larger than the capacitance Cg2 (Cg1>Cg2) based on a formula (i.e., C=ε·S/d, where ε represents permittivity, S represents electrode area of a capacitor, and d represents distance between electrodes of the capacitor) relating to capacitance of a capacitor. Thus, when considering that the capacitance Cf1 is almost the same as the capacitance Cf2, a relationship of Vgap1<Vgap2 holds between divided voltage Vgap1 of the voltage Vin applied to the capacitor Cg1 and divided voltage Vgap2 of the voltage Vin applied to the capacitor Cg2. As a result, a relationship Vfer1>Vfer2 is obtained based on the expressions (1) and (2) described above.

It can be understood from the above, the electrons accumulated in the vicinity of the point Q1 start to be emitted earlier than the electrons accumulated in the vicinity of the point Q2, because the potential Vfer1 of the point Q1 reaches the predetermined potential Vth earlier than the potential Vfer2 of the point Q2 when the voltage Vin between the upper electrode and the lower electrode increases. That is, as shown in FIG. 16, the electrons accumulated in the vicinity of the point Q1 start to be emitted when the voltage Vin between the upper electrode and the lower electrode reaches first voltage V1, and the electrons accumulated in the vicinity of the point Q2 start to be emitted when the voltage Vin between the upper electrode and the lower electrode reaches second voltage V2 which is larger than the first voltage V1.

As described above, in the conventional electron emitting device, the distance (gap distance) between the upper surface of the emitter section 101 and the lower surface of the upper electrode 103 is not constant. Therefore, in order to emit all of the electrons accumulated on the upper surface of the emitter section 101, very high voltage corresponding to the maximum gap distance must be applied between the upper electrode and the lower electrode. As a result, there is a problem that power consumption (corresponding to area surrounded by the Q-V curve shown in FIG. 16) by the conventional electron emitting device is large.

The present invention has been accomplished to solve the aforementioned problem, and one of the objects of the present invention is to provide an electron emitting device (or element) with low power consumption for emitting electrons.

The electron emitting device to accomplish the object comprising:
an emitter section composed of a dielectric material;
a lower electrode disposed on the lower side of the emitter section; and
an upper electrode disposed above the emitter section to oppose the lower electrode with the emitter section therebetween, the upper electrode having a plurality of micro through holes, a surface of a periphery of each micro through hole facing the emitter section being apart from the emitter section by a predetermined gap distance;

wherein electrons are accumulated on an upper surface of the emitter section when dipoles of the emitter section reverse in such a manner that negative poles of the dipoles are oriented toward the lower electrode in the case where potential of the upper electrode is lower than potential of the lower electrode, and electrons accumulated on the upper surface of the emitter section are emitted through the micro through holes when the dipoles of the emitter section reverse in such a manner that negative poles of the dipoles are oriented toward the upper electrode in the case where potential of the upper electrode is higher than potential of the lower electrode, and

wherein the upper electrode is configured in such a manner that said predetermined gap distance is substantially constant for any of said micro through holes.

With the structure above, when a voltage (electron emitting voltage for emitting the accumulated electrons) which renders the potential of the upper electrode positive with reference to the potential of the lower electrode is applied, the potential of the upper surface of the emitter section in the vicinity of any of the micro through holes becomes substantially constant (or substantially equal to each other), because the gap distance between the lower surface of the upper electrode in the vicinity of any of the micro through holes and the upper surface of the emitter section is substantially constant. Thus, when the electron emitting voltage reaches a certain (or a predetermined) value, the dipoles of the emitter section reverse all together (i.e., they reverse in a very short time) and the electrons are emitted all together. Accordingly, if the gap distance is made short, the electrons accumulated on the upper surface of the emitter section can assuredly be emitted even if the electron emitting voltage is low. That is, the electron emitting device (or element) with low power consumption for emitting electrons is provided.

In the case above, it is preferable that,

said upper electrode comprises;

micro through hole forming section which is a thin film-like and in which said micro through holes are formed; and

supporting section which supports said micro through hole forming section against said emitter section in such a manner that the lower surface of the micro through hole forming section is substantially parallel to the upper surface of the emitter section.

With this structure, the electron emitting device, with low power consumption, whose structure is simple, is provided. Notably, it is preferable that the thickness of the micro through hole forming section be substantially constant.

Further, it is preferable that said micro through hole forming section comprises projection portion which projects toward the upper surface of the emitter section.

If the micro through hole forming section comprises the projection portion, an electric field in the vicinity of the projection portion becomes large when a voltage (electron accumulating voltage for accumulating the electrons) which renders the potential of the upper electrode negative with reference to the potential of the lower electrode is applied. Thus, it is possible to supply the electrons to the upper surface of the emitter section from the upper electrode by the lower electron accumulating voltage (electron accumulating voltage whose absolute value is smaller). That is, the electron emitting device with much lower power consumption for accumulating and emitting the electrons is provided.

Meanwhile, it is preferable that a diameter of the micro through hole formed in the upper electrode be 0.1 μm or more and 0.5 μm or less (0.1-0.5 μm).

It should be noted that shape of the micro through hole in plan view is not limited. That is, the shape of the micro through hole may be a circular shape, a polygonal shape, an ellipse shape, and hyperelliptic shape, and the like. In any case, it is preferable that the diameter of the micro through hole be 0.1 μm or more and 0.5 μm or less in order for the electron emitting device to emit the electrons more effectively. The reasons follow.

If the diameter of the micro through hole is smaller than 0.1 μm, a ratio (or percentage) of the electrons, emitted form the emitter section, that are captured or trapped by the upper electrode becomes high.

If the diameter of the micro through hole is larger than 0.5 μm, it becomes harder for the dipoles to reverse in portions of the emitter section immediately under the micro through hole. Thus, it becomes harder for the electrons to be accumulated and emitted in such portions.

Furthermore, it is preferable that the gap distance be set in such a manner that, when a drive voltage Vin is the sum of an emitter section voltage Vfer and a gap voltage Vgap, the emitter section voltage Vfer is 50% or more of the drive voltage Vin, wherein the drive voltage Vin is a voltage applied between the lower electrode and the upper electrode, the emitter section voltage Vfer is a divided voltage of the drive voltage Vin and is applied to the emitter section between the lower electrode and the upper surface of the emitter section, and the gap voltage Vgap is a divided voltage of the drive voltage Vin applied to space between the upper surface of the emitter section and the lower surface of the upper electrode.

If the gap distance is set as above, the emitter section voltage can reach a voltage (or threshold) Vth for emitting the electrons even if the drive voltage Vin (or the electron emitting voltage Vin) is not so large. Thus, the power consumption of the electron emitting device can be reduced because the drive voltage Vin for emitting the electrons can be lowered.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a partial cross-sectional view of an electron emitting device according to a first embodiment of the present invention;

FIG. 2 is a partial plan view of the electron emitting device shown in FIG. 1;

FIG. 3 is a partial cross-sectional view of the electron emitting device shown in FIG. 1 under manufacturing process;

FIG. 4 is a partial cross-sectional view of the electron emitting device shown in FIG. 1 under manufacturing process;

FIG. 5 is a partial cross-sectional view of the electron emitting device shown in FIG. 1 under manufacturing process;

FIG. 6 is a partial cross-sectional view of the electron emitting device shown in FIG. 1 under manufacturing process;

FIG. 7 is a partial cross-sectional view of the electron emitting device shown in FIG. 1 under manufacturing process;

FIG. 8 is a graph showing the polarization-element voltage characteristic (Q-V characteristic) of the electron emitting device shown in FIG. 1;

FIG. 9 shows a state of the electron emitting device shown in FIG. 1 when the device accumulates electrons;

FIG. 10 shows another state of the electron emitting device shown in FIG. 1 when the device emits electrons;

FIG. 11 is a partial cross-sectional view of an electron emitting device according to a second embodiment of the present invention;

FIG. 12 is a partial cross-sectional view of an electron emitting device according to a third embodiment of the present invention;

FIG. 13 is a partial cross-sectional view of an electron emitting device according to a fourth embodiment of the present invention;

FIG. 14 is a partial cross-sectional view of an electron emitting device according to a fifth embodiment of the present invention;

FIG. 15 shows a state of a conventional electron emitting device;

FIG. 16 is a graph showing the polarization-element voltage characteristic (Q-V characteristic) of the conventional electron emitting device shown in FIG. 15;

FIG. 17 shows another state of the conventional electron emitting device shown in FIG. 15;

FIG. 18 shows another state of the conventional electron emitting device shown in FIG. 15;

FIG. 19 is a partial cross-sectional view of the conventional electron emitting device shown in FIG. 15 for explaining its operation.

### DESCRIPTION OF THE PREFERRED EMBODIMENTS

Embodiments of an electron emitting device (or element) according to the present invention will be described with reference to the drawings. The electron emitting device can be used for various applications, such as a light source utilizing phosphors (e.g., a backlight used for a liquid crystal display), a display, an electronic component manufacturing equipment, an electron irradiation device, and the like.

### First Embodiment

(Structure)

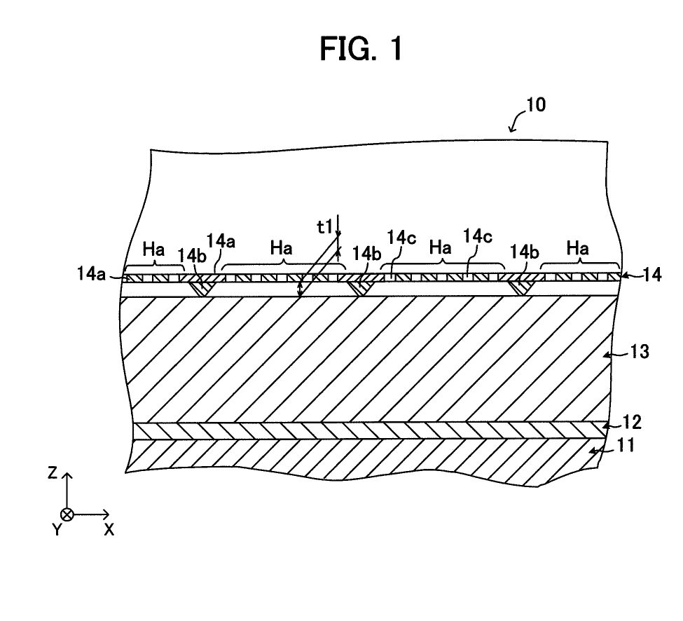

FIG. 1 is a partial cross-sectional view of an electron emitting device 10 according to a first embodiment of the present invention. The electron emitting device 10 includes a substrate 11, a lower electrode (lower electrode layer) 12, an emitter section 13, an upper electrode (upper electrode layer) 14.

The substrate 11 is a thin plate having an upper surface and a lower surface that are parallel to a plane (X-Y plane) defined by orthogonal X- and Y-axes. The thickness direction of the plate corresponds to a Z-axis direction, the Z-axis being orthogonal to both the X- and Y-axes. The substrate 11 is composed of a material including zirconium oxide as a major component (e.g., glass or a ceramic material).

The lower electrode 12 is a thin film composed of an electrically conductive material (e.g., platinum), and is disposed (formed) on the upper surface of the substrate 11.

The emitter section 13 is a thin plate similar to the substrate 11. The emitter section 13 is composed of a dielectric material having a high relative dielectric constant (e.g., a three-component material PMN-PT-PZ composed of lead magnesium niobate (PMN), lead titanate (PT), and lead zirconate (PZ)) or a ferroelectric material (Note that a “dielectric material” may include a “ferroelectric material” in the present specification). The emitter section 13 is disposed (formed) on the upper surfaces of the lower electrodes 12. Materials for the emitter section 13 are selected from materials having a small possible grain diameter. Thus, the upper surface of the emitter section is substantially flat and exists in a plane parallel to the X-Y plane.

The upper electrode 14 is composed of an electrically conductive material. The upper electrode 14 is disposed above the emitter section 13. The upper electrode 14 comprises a plane section 14a (or a flat section 14a) and a supporting section 14b.

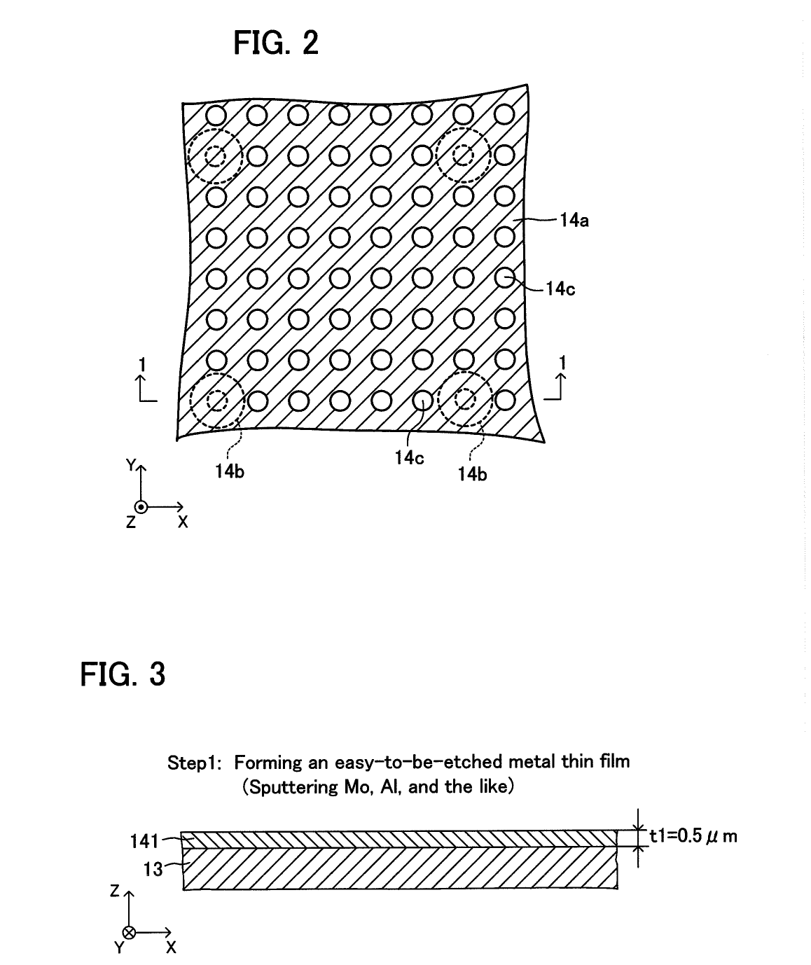

The plane section 14a is composed of a difficult-to-be-etched metal (i.e., a metal which is undissoluble in etching solution), such as Cr, Ag, and the like. The plane section 14a is a thin film. The thickness of the plane section 14a is 0.01 μm or more and 10 μm or less. An upper surface and a lower surface of the plane section 14a are parallel to the upper surface of the emitter section 13. In other words, each of the upper surface and the lower surface of the plane section 14a is disposed in a plane parallel to the X-Y plane. Distance (gap distance) t1 between the lower surface of the plane section 14a and the upper surface of the emitter section 13 is about 0.5 μm. As shown in FIG. 1 and FIG. 2 which is a plan view of the plane section 14a, a plurality of micro through holes 14c are formed (provided) in the plane section 14a. A shape of each micro through holes 14c in plan view is circular substantially. In plan view, a center of each of the micro through holes 14c is placed on (or, agrees to, is aligned with) a lattice point of a square lattice. A portion of a part of the plane section 14a where the micro through holes 14c are formed is called a micro through holes forming section Ha.

Notably, the shape of each micro through holes 14c in plan view is not limited to circular shape, but may be a polygonal shape, an ellipse shape, hyperelliptic shape, and the like. Further, when assuming that the shape of the micro through hole 14c is substantially circular, it is preferable that the diameter of the micro through hole 14c be 0.1 μm or more and 0.5 μm or less in order to emit the electrons more effectively. The reasons follow.

If the diameter of the micro through hole is smaller than 0.1 μm, a ratio (or percentage) of the electrons, emitted form the emitter section, that are captured or trapped by the upper electrode becomes high.

If the diameter of the micro through hole is larger than 0.5 μm, it becomes harder for the dipoles to reverse in portions of the emitter section immediately under (beneath) the micro through holes 14c. Thus, it becomes harder for the electrons to be accumulated and emitted in such portions.

The supporting section 14b is composed of an easy-to-be-etched metal (i.e., a metal which is dissoluble in etching solution and is removed (or eliminated) easily by the etching solution), such as Mo, Al, and the like. The supporting section 14b has a reversed circular truncated cone shape whose top surface is disposed at a lower side (i.e., the emitter section 13 side or the negative Z axis direction side) and whose bottom surface is disposed at an upper side (i.e., the positive Z axis direction side). Hereinafter, the top surface disposed at the lower side is called a lower surface and the bottom surface disposed at the upper side is called an upper surface.

The lower surface of the supporting section 14b is abutted against the upper surface of the emitter section 13. The upper surface of the supporting section 14b is butted against the lower surface of the plane section 14a. The supporting section 14b supports the plane section 14a in such a manner that the lower surface of the plane section 14a is parallel to the upper surface of the emitter section 13 (the lower surface of the plane section 14a being the lower surface of the upper electrode 14 in the vicinity of the micro through holes 14c which opposes the emitter section 13, or the lower surface of the plane section 14a being the lower surface of the micro through holes forming section Ha).

### <Manufacturing Method>

Next, one of examples of manufacturing methods for the electron emitting device will be described.

(Lower Electrode 12)

For the lower electrode 12, an electrically conductive material (e.g., a metal conductor such as platinum, molybdenum, tungsten, gold, silver, copper, aluminum, nickel, chromium, and the like) is used. Examples of the preferable materials for the lower electrode are as follows:

### (1) Conductors resistant to high-temperature oxidizing atmosphere (e.g., elemental metals or alloys)

Examples: high-melting-point metals such as platinum, iridium, palladium, rhodium, and molybdenum

Examples: materials mainly composed of a silver-palladium alloy, a silver-platinum alloy, or a platinum-palladium alloy

### (2) Mixtures of ceramics having electrical isolation and being resistant to high-temperature oxidizing atmosphere and elemental metals

Example: a cermet material of platinum and a ceramic

### (3) Mixtures of ceramics having electrical isolation and being resistant to high-temperature oxidizing atmosphere and alloys

### (4) Carbon-based or graphite-based materials

The lower electrode 12 may be formed by various film forming processes. For example, the lower electrode 12 may be formed by one of the suitable methods selected from thick film forming processes, such as a screen printing process, a spraying process, and a dipping process, etc., and thin film forming processes, such as an ion-beam process, a sputtering process, a vacuum deposition process, an ion-plating process, a chemical vapor deposition (CVD) process, and a plating process, etc.

(Emitter Section 13)

The dielectric material that constitutes the emitter section 13 may be a dielectric material or a ferroelectric material, each having a relatively high relative dielectric constant (for example, a relative dielectric constant of 1,000 or higher). Examples of the preferable material for the emitter section 13 follow. As described before, it should be noted that the material that constitutes the emitter section 13 is selected from materials having a small possible grain diameter.

(1) Barium titanate, lead zirconate, lead magnesium niobate, lead nickel niobate, lead zinc niobate, lead manganese niobate, lead magnesium tantalate, lead nickel tantalate, lead antimony stannate, lead titanate, lead magnesium tungstate, and lead cobalt niobate, and the like

### (2) Ceramics containing any combination of the substances listed in (1) above

(3) Ceramics described in (2) further containing an oxide of lanthanum, calcium, strontium, molybdenum, tungsten, barium, niobium, zinc, nickel, or manganese, etc.; ceramics described in (2) further containing any combination of the oxides described above which may or may not contain other appropriate compounds

### (4) Materials mainly containing 50% or more of the materials listed in (1) above

For example, PMN:PT:PZ of 0.375:0.375:0.25 yields a relative dielectric constant of 5,500, and PMN:PT:PZ of 0.5:0.375:0.125 yields a relative dielectric constant of 4,500. These compositions are particularly preferable as the material for the emitter section.

The emitter section 13 may be formed by the following steps.

Step 1; Forming a thin film like layer (or a thin plate) having a certain thickness with the material described above by a screen printing process on the substrate 11 and the lower electrode 12. Note that, instead of the screen process, one of various thick film forming processes may be used such as a dipping process, an application process, an electrophoresis process, a precipitation process, an aerosol deposition process, etc. Further, one of various thin-film forming processes may be used, such as an ion-beam process, a sputtering process, a vacuum deposition process, an ion-plating process, a chemical vapor deposition (CVD) process, and a plating process, etc.

Step 2; Heating the printed layer to be fired (burnt) at a predetermined temperature with an electrical furnace and oven. As a result, the emitter section 13 is manufactured. Notably, It may be preferable that the emitter section 13 be fired at a temperature slightly lower than a normal temperature for firing in order for the upper surface of the emitter section 13 to become as flat or even as possible.

(Upper Electrode 14)

The upper electrode 14 may be formed by the following steps.

Step 1; As shown in FIG. 3, forming a film 141 having a predetermined thickness t1 on the emitter section 13 by a sputtering process, the film 141 consisting of the easy-to-be-etched metal (e.g., Mo). This film may be composed of Al, and the like.

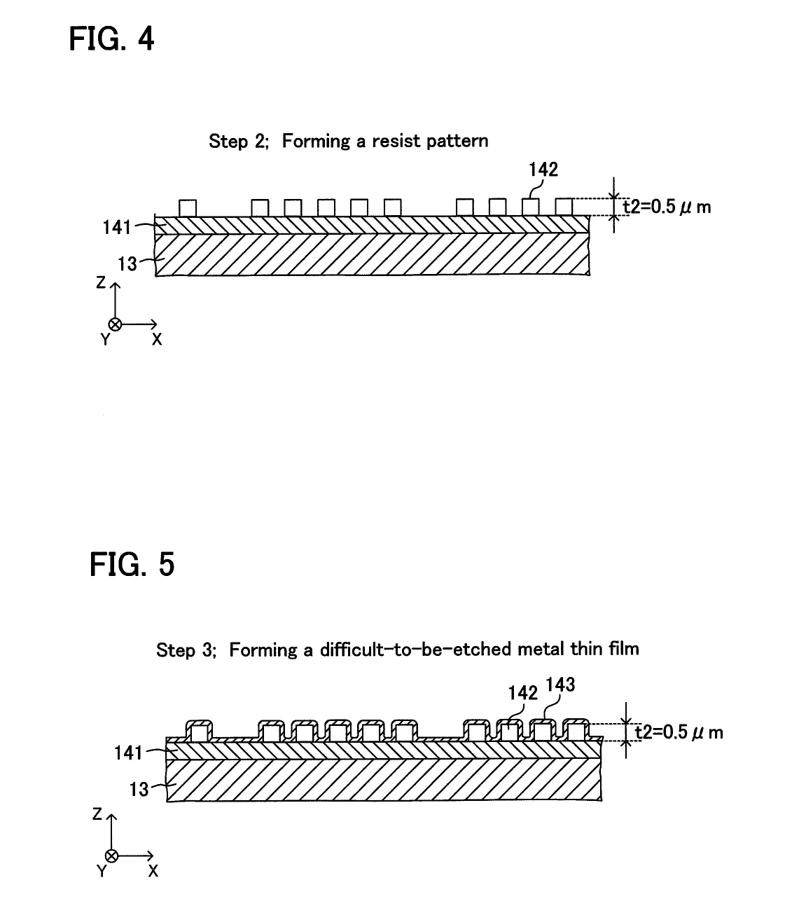

Step 2; As shown in FIG. 4, forming a resist 142 having a predetermined pattern on the easy-to-be-etched metal film 141 by a photolithography process. The height t2 of the resist is roughly equal to the height t1 (i.e., the thickness t1) of the easy-to-be-etched metal film 141 (e.g., 0.5 μm).

Step 3; As shown in FIG. 5, forming a thin film 143 consisting of the difficult-to-be-etched metal (e.g., a thin film composed of Cr) on the resist 142 formed in Step 2. This film 143 may be formed of Ag, etc.

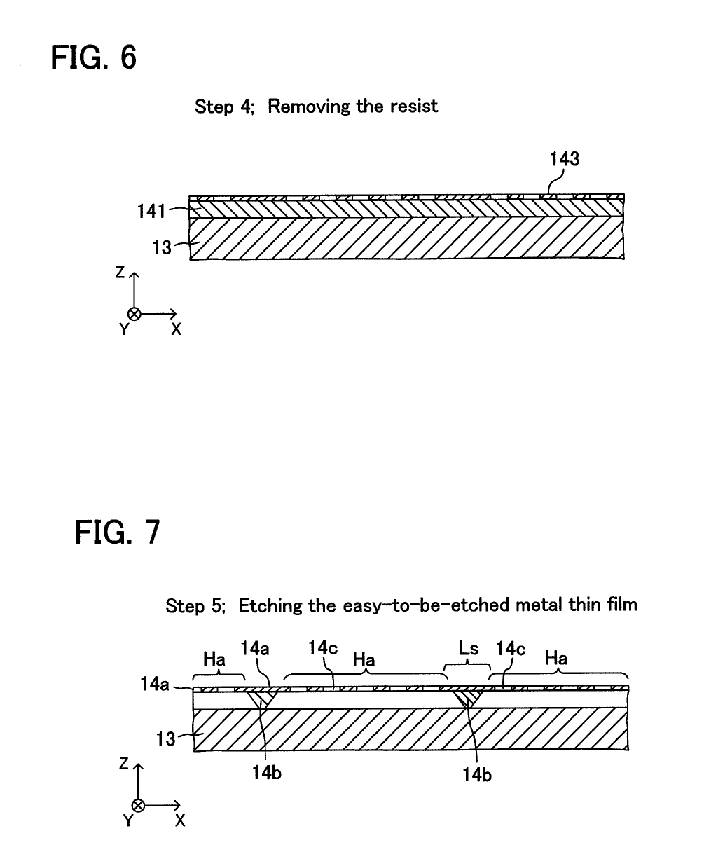

Step 4; Removing the resist 142 formed in Step 2. As a result, as shown in FIG. 6, portions of the difficult-to-be-etched metal thin film 143 formed in Step 3 are left, the portions abutting on the upper surface of the easy-to-be-etched metal film 141. At this stage, a pattern of the difficult-to-be-etched metal thin film 143 in plan view coincides with the pattern shown in FIG. 2. In other words, the resist 142 is formed in Step 2 to have the predetermined pattern such that the pattern shown in FIG. 2 should be obtained.

Step 5; Etching the easy-to-be-etched metal film 141 by a etching solution. Thus, as shown in FIG. 7, each of portions of the easy-to-be-etched metal film 141 immediately under each of the portions Ls of the difficult-to-be-etched metal thin film 143 is left to have the reversed circular truncated cone shape, the each of the portions Ls having a relatively large area. The left portion constitutes the supporting portion 14b described above. Meanwhile, the rest of the easy-to-be-etched metal film 141 is removed by the etching. As a result, the plane section 14a described above is formed by the difficult-to-be-etched metal thin film 143.

(Operation)

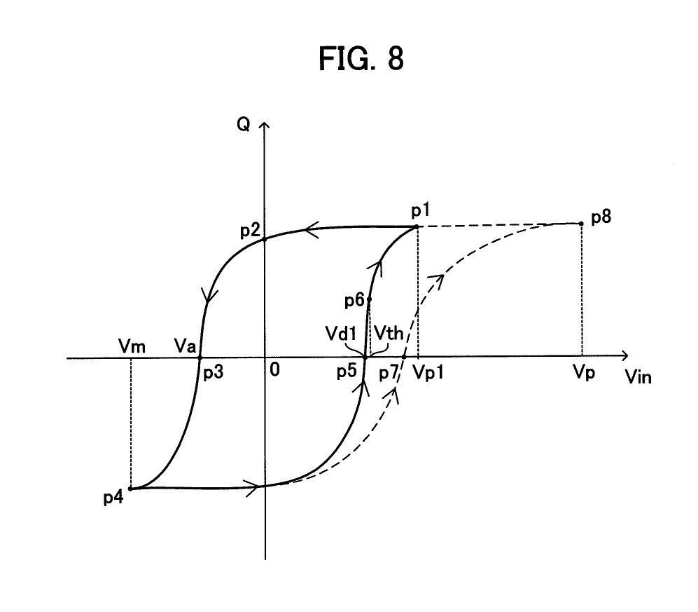

Next, operation of the electron emitting device having the above-described structure will now be described with reference to FIGS. 8 to 10. First of all, it is assumed that a predetermined positive voltage Vp is applied between the lower electrode and the upper electrode and that no electrons are accumulated on the upper surface of the emitter section 13. This state is observed at a point p1 on the graph in FIG. 8. In the graph of FIG. 8, the abscissa indicates the element voltage Vka and the ordinate indicates the charge Q on the upper surface of the emitter section 13. In other words, the graph in FIG. 8 shows the polarization-element voltage characteristic (Q-V characteristic) of the electron emitting device 10.

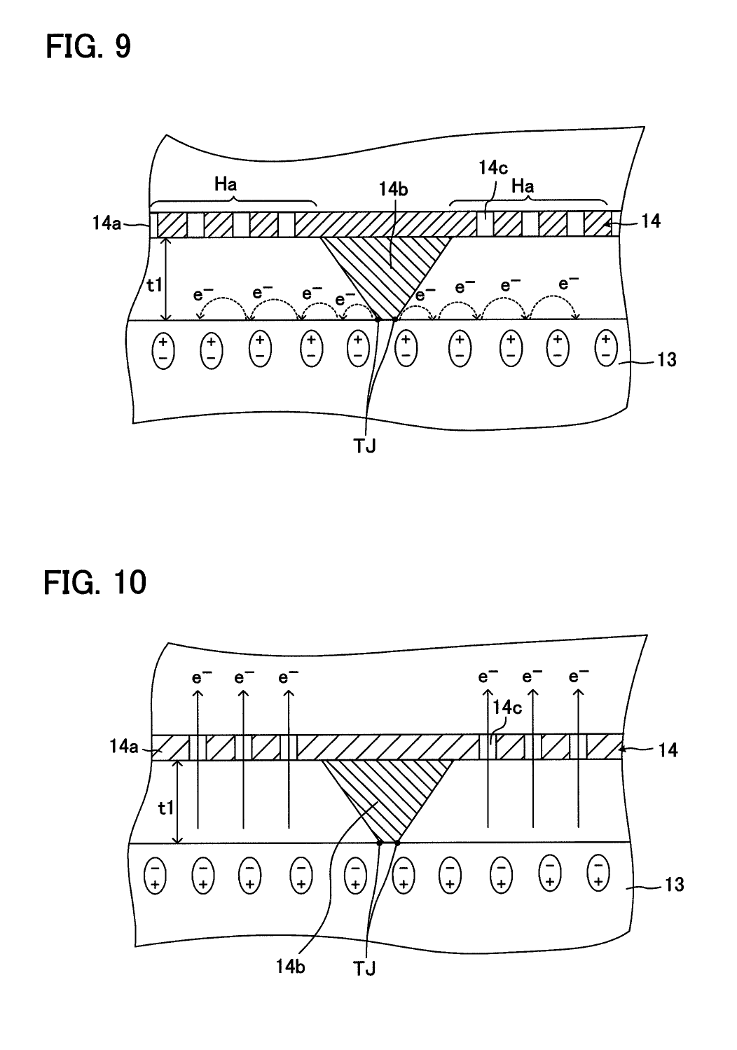

In the stage above, when a negative predetermined voltage Vm (or an electron accumulating voltage Vm) is applied between the upper electrode and the lower electrode, the element voltage Vka decreases. That is, the state of the electron emitting device 10 changes from the point p1 to a point p3 via a point p2 in FIG. 8. When the element voltage Vka approaches a negative coercive field voltage Va shown in FIG. 8, the dipoles in the emitter section 13 starts reversing in such a manner that the negative pole of the dipole is oriented toward the lower electrode 12. As shown in FIG. 9, this polarization reversal increases (strengthen) the electric field in the triple junctions TJ each of which is a contact site of the upper surface of the emitter section 13, the upper electrode 14 (or the supporting section 14b), and the ambient medium (in this embodiment, vacuum). As a result, electrons begin to be supplied to the upper surface of the emitter section 13 from the upper electrodes 14.

Subsequently, when the negative-side polarization reversal is completed after certain time, the element voltage Vka rapidly changes toward the negative predetermined voltage Vm, eventually reaching the negative predetermined voltage Vm. As a result, the electron accumulation is completed. This state is observed at a point p4 in FIG. 8.

Next, when a positive predetermined voltage Vp1 (or an electron emitting voltage Vp1) is applied between upper electrode and the lower electrode, the element voltage Vka starts to increase. During the increase, when the element voltage Vka exceeds a positive coercive field voltage Vd1 corresponding to a point p5 in FIG. 8, the negative pole of the dipole starts to orient toward the upper electrode 14, as shown in FIG. 10. In other words, a positive-side polarization reversal begins. Subsequently, the number of dipoles which completed the positive-side polarization reversal becomes larger than a certain number, and density of the dipoles that completed the positive-side polarization reversal exceeds certain value, when the element voltage Vka reaches a positive threshold voltage Vth corresponding to a point p6 in FIG. 8. As a result, as shown in FIG. 10, the electrons accumulated on the upper surface of the emitter section 13 are subject to Coulomb repulsion from the dipoles of the emitter section 13 and emitted through the micro through holes 14c in the upward direction in a short time. After all of the dipoles complete the positive-side polarization reversal, the element voltage Vka starts to increase rapidly and reaches the positive predetermined voltage Vp1.

As described above, in the electron emitting device 10 according to a first embodiment of the present invention, the distance (the gap distance) t1 any one of micro through holes 14c is constant for and minute (or very short), the distance t1 being a distance between the upper surface of the emitter section 13 and the lower surface of the upper electrode 14 (or the lower surface of the regions Ha where the micro through holes 14c are formed, i.e., the lower surface of the micro through holes forming section Ha). Thus, the electron emitting device 10 can emit the electrons virtually all together, when the element voltage Vka reaches the relatively small positive voltage Vth which is equal to or larger than the positive coercive field voltage Vd.

Here, the distance t1 (the gap distance t1) is described in detail. The following expression (3) holds, when the drive voltage Vin is applied between the lower electrode 12 and the upper electrode 14. In the expression (3), Vfer is an emitter voltage which is a divided voltage of the drive voltage Vin applied to the emitter section 13 between the lower electrode 12 and the upper surface of the emitter section 13, Vgap is a gap voltage which is a divided voltage of the drive voltage Vin applied to the space (or gap) between the upper surface of the emitter section 13 and the lower surface of the upper electrode 14.

Vin=Vfer+Vgap (3)

### That is, the drive voltage Vin is the sum of the emitter voltage Vfer and the gap voltage Vgap.

In the embodiment above, the gap distance t1 is selected (or set) in such a manner that (an absolute value of) the emitter voltage Vfer is 50% or more of (an absolute value of) the drive voltage Vin. In other words, when a distance t50% is defined as a gap distance obtained when the absolute value of the emitter voltage Vfer coincides with 50% of the absolute value of the drive voltage Vin, the gap distance t1 is determined to satisfy the following equation (4).

t1≦t50% (4)

As the gap distance t1 is set as described above, even if the drive voltage Vin (or the electron emitting voltage Vin) is not so large, the emitter voltage Vfer can reach the voltage Vth for emitting electrons. Accordingly, since the drive voltage Vin (or the electron emitting voltage Vin) can be set at small voltage, power consumption by the electron emitting device 10 can be reduced.

The Q-V characteristic of the electron emitting device 10 having the structure described above varies as shown by a solid line in FIG. 8 (i.e., in such a manner that the points p1, p2, p3, p4, p5, p6, and p1 are passed through). To the contrary, the Q-V characteristic of the conventional electron emitting device varies in accordance with a line shown by the solid line and a dotted line to pass through the points p8, p1, p2, p3, p4, p7, and p8. A portion surrounded by a closed curve in the Q-V characteristic represents power consumption of an electron emitting device. Accordingly, it is understood that, from FIG. 8, the electron emitting device 10 according to the present embodiment consumes power (for accumulation and emission of the electrons) lower than power (for the same) which the conventional electron emitting device consumes.

### Second Embodiment

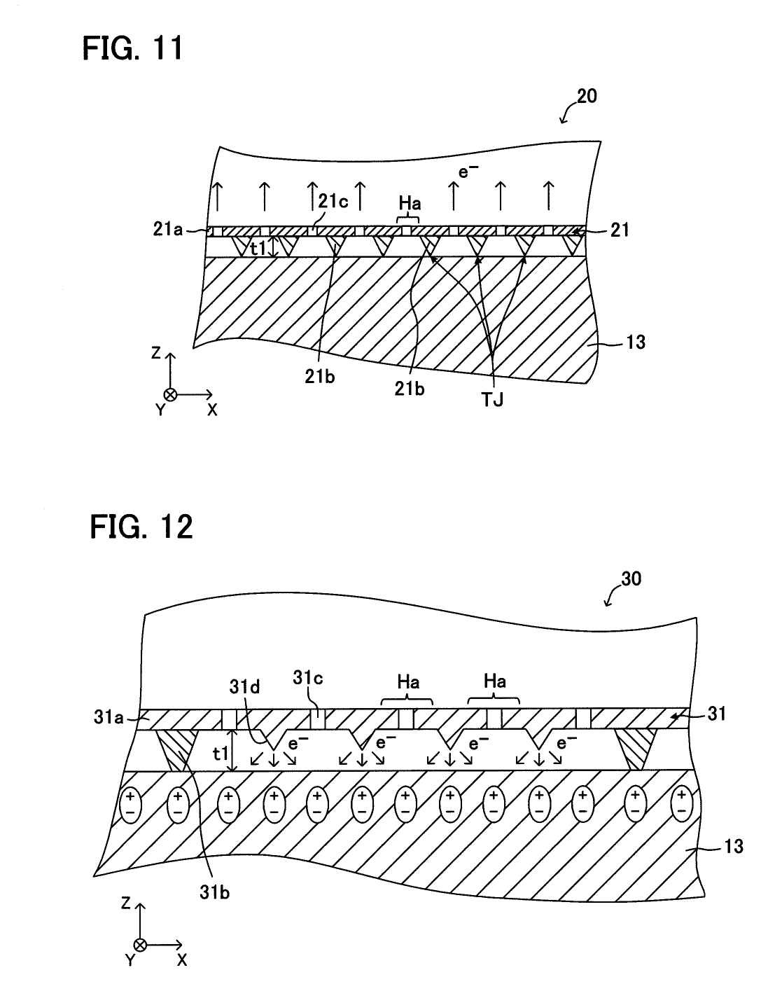

An electron emitting device 20 according to a second embodiment of the present invention differs from the electron emitting device 10 according to the first embodiment, as shown in FIG. 11, only in that the upper electrode 14 of the electron emitting device 10 of the first embodiment is replaced by an upper electrode 21. Thus, hereinafter, the description will be made by focusing on this difference.

The upper electrode 21 comprises a plane section 21a (or a flat section 21a) and a supporting section 21b. The plane section 21a is substantially identical to the plane section 14a of the first embodiment. The supporting section 21b is configured in such a manner that the supporting section 21b surrounds each of the micro through holes 21c. Regions (or portions) of a lower surface of the plane section 21a where micro through holes 21c are formed and their vicinities (i.e., a lower surface of the micro through hole forming section Ha) are parallel to the upper surface of the emitter section 13. That is, distance (gap distance) between the regions of the lower surface of the plane section 21a in the vicinity of the micro through holes 21c and the upper surface of the emitter section 13 is predetermined constant distance t1 anywhere (i.e., for any one of micro through holes 21c).

The electron emitting device 20 operates in substantially the same way as the electron emitting device 10. Thus, the electron emitting device 20 can emit electrons with lower power consumption compared to the conventional electron emitting device. Further, in the electron emitting device 20, the number of the supporting section 21b per one micro through hole 21c is larger than the number of the supporting section 14b per one micro through hole 14c in the electron emitting device 10. Therefore, in the electron emitting device 20, the plane section 21a can be supported for a long time steadily. Furthermore, a greater number of the triple junctions TJ each of which is a contact site of the supporting section 21b, the upper surface of the emitter section 13, and the ambient medium can be formed. As a result, the electron emitting device 20 can accumulate a larger number of electrons on the upper surface of the emitter section 13 with much lower power consumption.

### Third Embodiment

An electron emitting device 30 according to a third embodiment of the present invention differs from the electron emitting device 10 according to the first embodiment, as shown in FIG. 12, only in that the upper electrode 14 of the electron emitting device 10 of the first embodiment is replaced by an upper electrode 31. Thus, hereinafter, the description will be made by focusing on this difference.

The upper electrode 31 comprises a plane section 31a (or a flat section 31a) and a supporting section 31b.

The plane section 31a comprises a plurality of micro through holes, similarly to the plane section 14a of the first embodiment. A projection portion 31d which projects toward the upper surface of the emitter section 13 from the plane section 31a is formed on the lower surface of the plane section 31a between one micro through hole 31c and another micro through hole 31c adjacent to that one micro through hole 31c. The projection portion 31d has a reversed circular cone shape. That is, the bottom surface of the projection portion 31d is connected with the plane section 31a. The head (or the tip) of the projection portion 31d comes close to the upper surface of the emitter section 13. Regions (or portions) of a lower surface of the plane section 31a where micro through holes 31c are formed and their vicinities (i.e., a lower surface of the micro through hole forming section Ha) are parallel to the upper surface of the emitter section 13. That is, distance (gap distance) between the regions of the lower surface of the plane section 31a in the vicinity of the micro through holes 31c and the upper surface of the emitter section 13 is predetermined constant distance t1 anywhere (i.e., for any one of micro through holes 31c).

The supporting section 31b has a reversed circular truncated cone shape. A lower surface of the supporting section 31b is abutted against and connected with the upper surface of the emitter section 13. The upper surface of the supporting section 31b is butted against the lower surface of the plane section 31a. The supporting section 31b supports the plane section 31a in such a manner that the lower surface of the plane section 31a is parallel to the upper surface of the emitter section 13, the lower surface of the plane section 31a being the lower surface of the plane section 31a in the vicinity of the micro through holes 31c and its vicinities (i.e., the lower surface of the micro through holes forming section Ha).

The electron emitting device 30 operates in substantially the same way as the electron emitting device 10. Further, when the dipoles in the emitter section 13 undergo the negative polarization reversal as the element voltage Vka approaches a negative coercive field voltage Va by applying the electron accumulating voltage between the upper electrode and the lower electrode, a large (or strong) electric field in the vicinity of the head of the projection portion emerges. Thus, electrons are supplied to the upper surface of the emitter section 13 from the each head of the projection portions 31d. As a result, the electron emitting device 30 can accumulate the electrons on the upper surface of the emitter section 13 with much lower power consumption compared to the conventional electron emitting device, since the device 30 includes projection portions 31d. In addition, the electron emitting device 30 can emit the electrons similarly to the electron emitting devices 10 and 20 with lower power consumption compared to the conventional electron emitting device.

### Fourth Embodiment

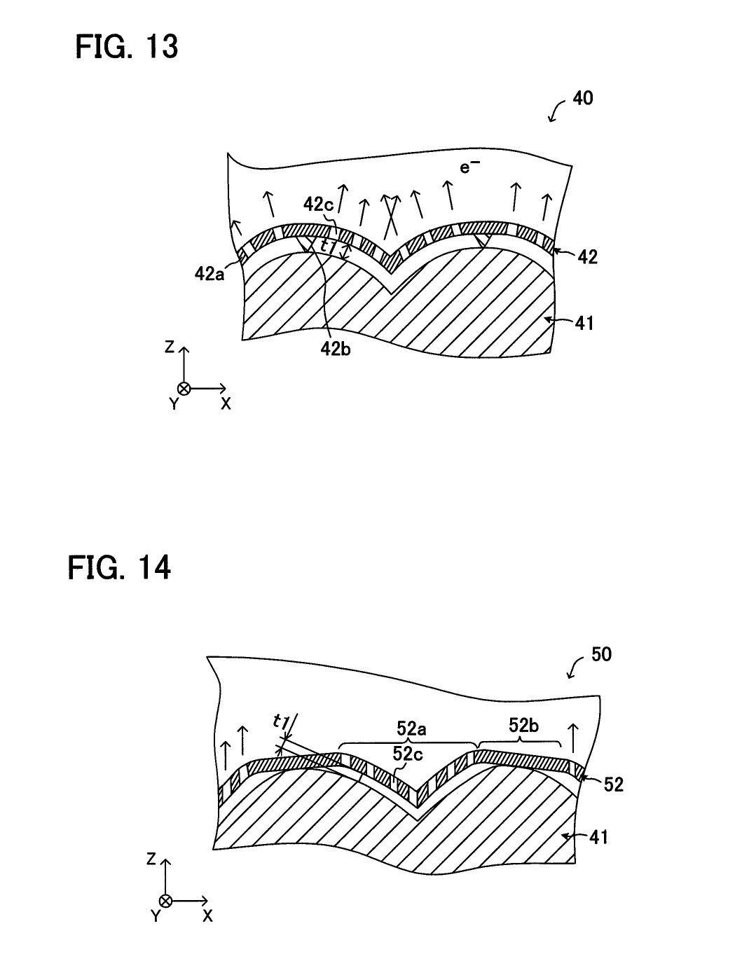

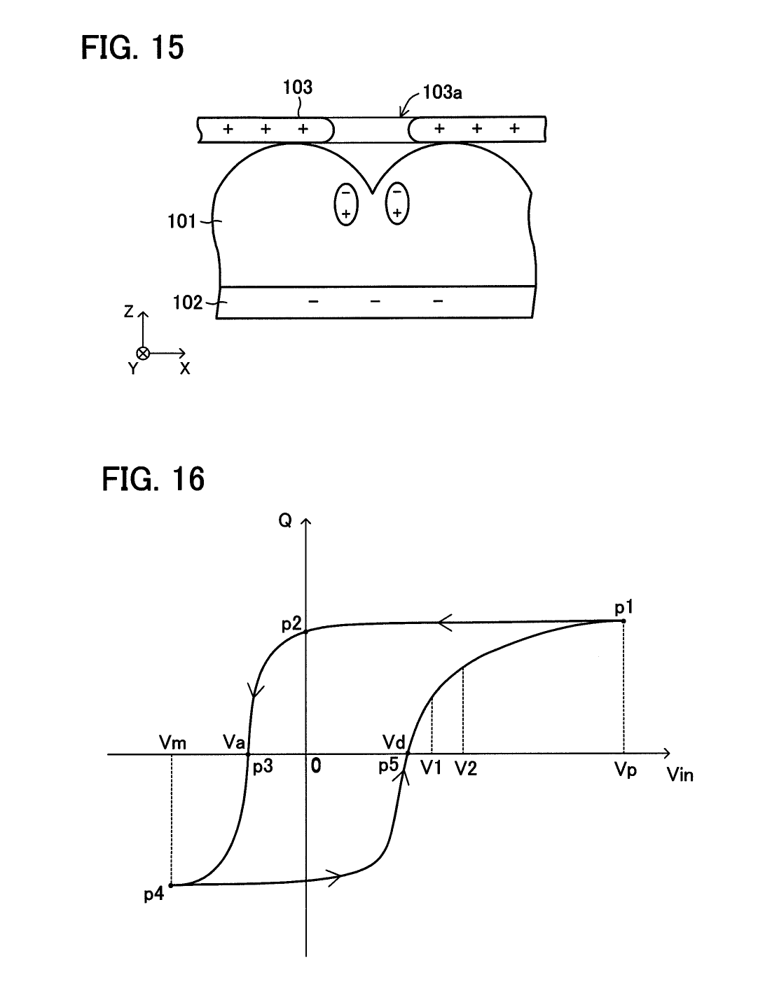

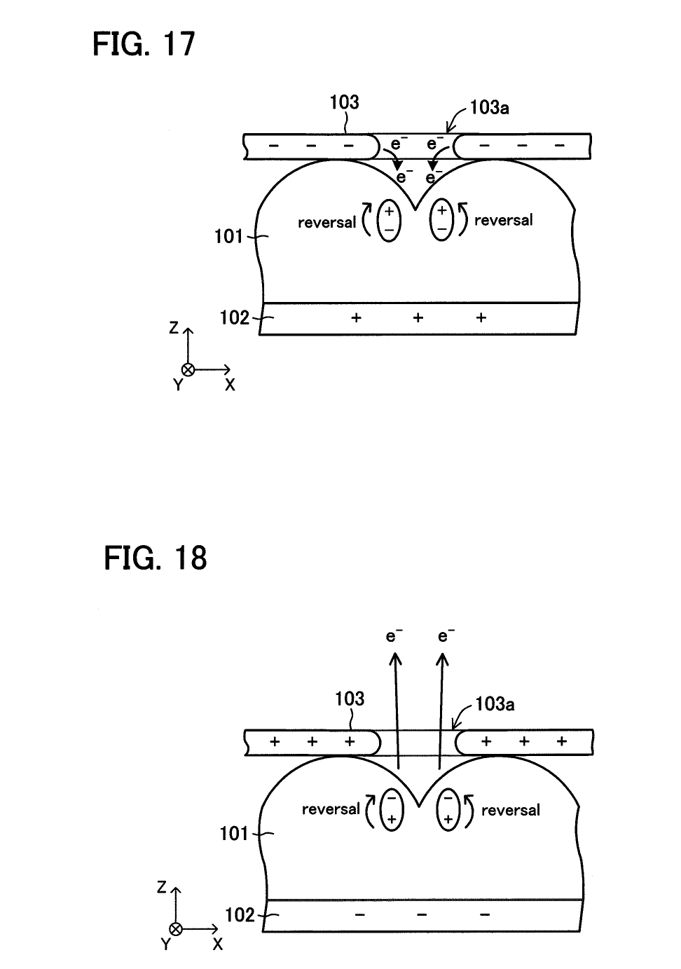

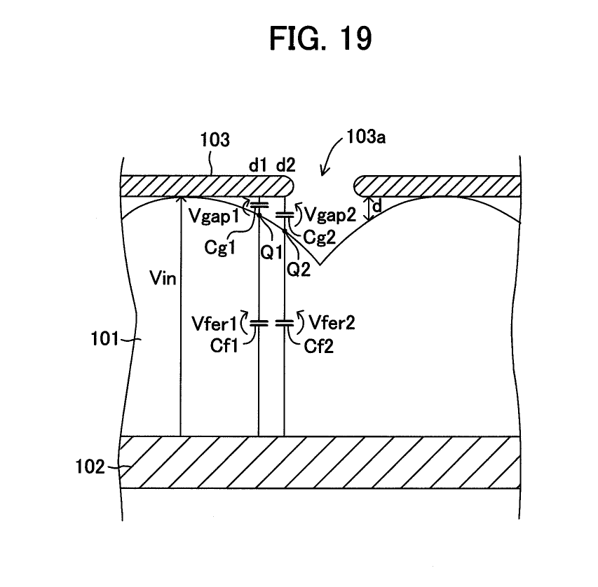

An electron emitting device 40 according to a fourth embodiment of the present invention differs from the electron emitting device 10 according to the first embodiment, as shown in FIG. 13, only in that the emitter section 13 and the upper electrode 14 of the electron emitting device 10 of the first embodiment are replaced by an emitter section 41 and an upper electrode 42, respectively. Thus, hereinafter, the description will be made by focusing on these differences.

The emitter section 41 is composed of a material whose grain diameter larger than the grain diameter of the material that constitutes the emitter section 13. Thus, the upper surface of the emitter section 41 has irregularities (asperity) formed by the grain boundaries of the material.

The upper electrode 42 is composed of the electrically conductive material. The upper electrode 42 is disposed above the emitter section 41. The upper electrode 42 comprises a curved surface section 42a and a supporting section 42b.

The curved surface section 42a is composed of the difficult-to-be-etched metal, such as Cr and Ag. The curved surface section 42a is a thin film having constant thickness. The thickness of the curved surface section 42a is 0.01 μm or more and 10 μm or less. A lower surface of the curved surface section 42a is formed so as to be a curved surface in such a manner that distance t1 (gap distance t1) between the lower surface of the curved surface section 42a and the upper surface of the emitter section 41 is kept constant (about 0.5 μm). A plurality of micro through holes 42c similar to the micro through holes 14c are formed in the curved surface section 42a.

The supporting section 42b is composed of the easy-to-be-etched metal, such as Mo and Al. The supporting section 42b has a reversed circular truncated cone shape similarly to the supporting section 14b. Hereinafter, the top surface of the supporting section 42b disposed at the lower side is called a lower surface and the bottom surface of supporting section 42b disposed at the upper side is called an upper surface.

The lower surface of the supporting section 42b is abutted against the upper surface of the emitter section 41. The upper surface of the supporting section 42b is butted against the lower surface of the curved surface section 42a. The supporting section 42b supports the curved surface section 42a in such a manner that the lower surface of the curved surface section 42a is parallel to the upper surface of the emitter section 41.

The electron emitting device 40 operates in substantially the same way as the electron emitting device 10. In the electron emitting device 40, the upper surface of the emitter section 41 has irregularities formed by the grain boundaries of the material. However, regions (or portions) of the lower surface of the curved surface section 42a where micro through holes 42c are formed and their vicinities (i.e., a lower surface of the micro through hole forming section) are parallel to the upper surface of the emitter section 41. In other words, the gap distance t1 between the lower surface of the curved surface section 42a around the micro through holes 42c and the upper surface of the emitter section 41 is kept constant anywhere on the emitter section 41 (i.e., for any one of micro through holes 42c). Thus, the electron emitting device 40 can emit electrons with lower power consumption compared to the conventional electron emitting device.

### Fifth Embodiment

An electron emitting device 50 according to a fifth embodiment of the present invention differs from the electron emitting device 40 according to the fourth embodiment, as shown in FIG. 14, only in that the upper electrode 42 of the electron emitting device 40 of the fourth embodiment is replaced by an upper electrode 52. Thus, hereinafter, the description will be made by focusing on the difference.

The upper electrode 52 is composed of electrically conductive material and is a thin film having constant thickness. The thickness of the upper electrode 52 is 0.01 μm or more and 10 μm or less. The upper electrode 52 comprises a micro through hole forming section 52a and a supporting section 52b.

The micro through hole forming section 52a is disposed on the upper side (or above) the concave portion formed by the grain boundaries on the upper surface of the emitter section 41. The micro through hole forming section 52a is a thin film having constant thickness. A lower surface of the micro through hole forming section 52a is formed so as to be a curved surface in such a manner that distance t1 (gap distance t1) between the lower surface of the micro through hole forming section 52a and the upper surface of the emitter section 41 is kept constant (about 0.5 μm). That is, the lower surface of the micro through hole forming section 52a substantially follows a shape of the upper surface of the emitter section 41. A plurality of micro through holes 52c similar to the micro through holes 14c are formed in the micro through hole forming section 52a.

The supporting section 52b is substantially a flat plate. Each of both ends of the supporting section 52b is connected with the micro through hole forming section 52a. A part of the lower surface of the supporting section 52b abuts on a convex portion of the emitter section 41. Thus, the supporting section 52b supports the micro through hole forming section 52a in such a manner that the lower surface of the micro through hole forming section 52a is parallel to the upper surface of the emitter section 41.

The electron emitting device 50 operates in substantially the same way as the electron emitting device 10. In the electron emitting device 50, the upper surface of the emitter section 41 has irregularities formed by the grain boundaries of the material. However, regions (or portions) of the lower surface of the upper electrode 52 where micro through holes 52c are formed and their vicinities (i.e., the lower surface of the micro through hole forming section 52a) are parallel to the upper surface of the emitter section 41. Thus, the electron emitting device 50 can emit electrons with lower power consumption compared to the conventional electron emitting device. Further, the upper electrode 52 of the electron emitting device 50 can be formed by screen printing paste-like organometallic compound mainly containing Platinum on the emitter section 41 and thereafter firing the compound. Thus, compared to the manufacturing method including the etching process described above, the upper electrode 52 can be made more easily.

As described above, the electron emitting device according to each embodiment of the present invention is an element that has a structure in which distance (gap distance) between portions of the lower surface of the upper electrode where micro through holes are formed and their vicinities (i.e., the lower surface of the micro through hole forming section) and the upper surface of the emitter section is minute constant distance. In other words, the upper electrode is configured in such a manner that the distance (gap distance) between the regions of the lower surface of the upper electrode in the vicinity of the micro through holes and the upper surface of the emitter section is substantially constant distance for any (one) of the micro through holes. Thus, when a predetermined positive voltage (electron emitting voltage for emitting the accumulated electrons) is applied between the upper electrode and the lower electrode, the potential of the portions of the emitter section immediately under the micro through holes and/or in the vicinity of the micro through holes reaches the potential required to emit electrons substantially simultaneously. Accordingly, the device can emit electrons accumulated on the upper surface of the emitter section all together. As a result, the electron emitting device (or element) with lower power consumption for emitting electrons is provided, compared to the conventional electron emitting device.

The present invention is not limited to the embodiments described above and various other modifications and alternations are possible without departing from the scope of the invention. For example, each of the electron emitting devices may comprise a white phosphor above the upper electrode. By the device, the white phosphor emits white light by the electrons emitted by the electron emitting device. Thus, this type of device can be used as a light source including a backlight used for a liquid crystal display. Also, a color display may be provided by disposing a phosphor for emitting red light, a phosphor for emitting green light, and a phosphor for emitting blue light above the upper electrode.

What is claimed is:

1. A electron emitting device comprising:
an emitter section composed of a dielectric material;
a lower electrode disposed on the lower side of the emitter section; and
an upper electrode disposed above the emitter section to oppose the lower electrode with the emitter section therebetween, the upper electrode having a plurality of micro through holes, a surface of a periphery of each micro through hole facing the emitter section being apart from the emitter section by a predetermined gap distance;
wherein electrons are accumulated on an upper surface of the emitter section when dipoles of the emitter section reverse in such a manner that negative poles of the dipoles are oriented toward the lower electrode in the case where potential of the upper electrode is lower than potential of the lower electrode, and electrons accumulated on the upper surface of the emitter section are emitted through the micro through holes when the dipoles of the emitter section reverse in such a manner that negative poles of the dipoles are oriented toward the upper electrode in the case where potential of the upper electrode is higher than potential of the lower electrode, and
wherein the upper electrode is configured in such a manner that said predetermined gap distance is substantially constant for any of said micro through holes.

2. The electron emitting device according to claim 1, wherein said upper electrode comprises;
micro through hole forming section which is a thin film-like and in which said micro through holes are formed; and
supporting section which supports said micro through hole forming section against said emitter section in such a manner that the lower surface of the micro through hole forming section is substantially parallel to the upper surface of the emitter section.

3. The electron emitting device according to claim 2, wherein said micro through hole forming section comprises projection portion which projects toward the upper surface of the emitter section.

4. The electron emitting device according to claim 1, a diameter of the micro through hole formed in the upper electrode be 0.1 μm or more and 0.5 μm or less.

5. The electron emitting device according to claim 1, wherein said gap distance is set in such a manner that, when a drive voltage Vin is the sum of an emitter section voltage Vfer and a gap voltage Vgap, the emitter section voltage Vfer is 50% or more of the drive voltage Vin, wherein the drive voltage Vin is a voltage applied between the lower electrode and the upper electrode, the emitter section voltage Vfer is a divided voltage of the drive voltage Vin and is applied to the emitter section between the lower electrode and the upper surface of the emitter section, and the gap voltage Vgap is a divided voltage of the drive voltage Vin applied to space between the upper surface of the emitter section and the lower surface of the upper electrode.
